(19) United States
(12) Patent Application Publication
(10) Pub. No.: US 2007/0217433 A1
(43) Pub. Date: Sep. 20, 2007

(54) Apparatus, method and computer program product providing relay division multiple access

(75) Inventors: Klaus Doppler, Espoo (FI); Ari Hottinen, Espoo (FI); Taneli Riihonen, Espoo (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/724,020

(22) Filed: Mar. 14, 2007

Related U.S. Application Data
(60) Provisional application No. 60/782,548, filed on Mar. 14, 2006.

(51) Int. Cl. H04L 12/56

(52) U.S. Cl. 370/400

(57) ABSTRACT

An apparatus, computer program and method are provided. A first control signal is received from a first network node and a second control signal is received from a second network node. From the received first and second control signals is determined a first relative weight and a second relative weight. A first message is received and a second message is received, which may be from different sources. The received first message is relayed by transmitting it after amplifying according to the first relative weight, and the received second message is relayed by transmitting it after amplifying according to the second relative weight. The relayed messages may be transmitted to different destinations, and in a full duplex mode. Further aspects include using the relative weights to load balance or set network coverage area as between the network nodes.

### CROSS-REFERENCE TO RELATED APPLICATIONS

This patent application claims priority under 35 U.S.C. §119(e) from U.S. Provisional Patent Application No. 60/782,548, filed on Mar. 14, 2006, the disclosure of which is incorporated by reference herein in its entirety.

### TECHNICAL FIELD

This disclosure relates generally to wireless communications systems, methods and computer program products and, more specifically, to radio frequency (RF) communication systems that employ one or more relay nodes between a transmitter and a receiver.

### BACKGROUND

Various conventional techniques used to provide multiple access in cellular communication networks include the use of, as examples, code division multiple access (CDMA), time division multiple access (TDMA) and frequency division multiple access (FDMA).

In conventional cellular systems the same channels cannot be used in adjacent cells. As such, the frequency reuse factor (i.e. the rate at which the same frequency can be used in the network) is typically 1/7 or less, that is, the mobile nodes present in each cell can only use 1/7 of the available cellular frequency channels at any given time. Since the wireless medium is a scarce resource, any cellular system that could provide a frequency reuse factor of 1/1 (i.e. unity) would be desirable, as all available frequencies within each cell could be used.

In addition to the foregoing, it would be desirable for base stations (where each base station supports a cell) to exhibit overlapping coverage areas. This would facilitate the use of load balancing and soft handovers between cells. For the load balancing case, and for those mobile nodes that are in the coverage area of two or more base stations, there would be provided a capability to avoid connecting to a heavily loaded base station. This would increase the total average cellular network performance and overall usage. For the soft handover case, a given mobile node can connect to two or more base stations simultaneously.

Prior to this invention there existed no truly satisfactory solution to the problems of providing an enhanced load balancing and soft handover capability for mobile nodes in a cellular network.

### SUMMARY

A method is provided, wherein the method includes receiving a first control signal from a first network node and receiving a second control signal from a second network node. From the received first and second control signals is determined a first relative weight and a second relative weight. Further in the method is received a first message and a second message. The received first message is relayed by transmitting it after amplifying according to the first relative weight, and the received second message is relayed by transmitting it after amplifying according to the second relative weight.

An apparatus is provided, wherein the apparatus includes a receiver, a processor coupled to a memory and an amplifier coupled to a transmitter. The receiver is configured to receive a first control signal from a first network node and a second control signal from a second network node. The processor is coupled to the memory (which embodies computer instructions) and to the receiver, and is configured to determine from the received first and second control signals a first relative weight and a second relative weight. The transmitter is configured to relay a received first message by transmitting it after amplifying according to the first relative weight, and to relay a received second message by transmitting it after amplifying according to the second relative weight.

In accordance with another embodiment is provided a computer program product of machine-readable instructions, tangibly embodied on a memory and executable by a digital data processor, to perform actions directed toward relaying messages in a network. The actions include determining, from a first control signal received from a first network node and from a second control signal received from a second network node, a first relative weight and a second relative weight. The actions further include relaying a received first message by transmitting it after amplifying the received first message according to the first relative weight, and relaying a received second message by transmitting it after amplifying according to the second relative weight.

Furthermore, an apparatus is provided in another embodiment, wherein the apparatus includes means for receiving a first control signal from a first network node and for receiving a second control signal from a second network node, means for determining from the received first and second control signals a first relative weight and a second relative weight, and means for relaying a first received message by transmitting the first received message after amplifying according to the first relative weight and for relaying a second received message by transmitting the second received message after amplifying according to the second relative weight. In a particular embodiment the means for receiving comprises a receiver, the means for determining comprises a processor coupled to a memory of computer readable instructions, and the means for relaying comprises an amplifier coupled to a transmitter.

In accordance with another embodiment is a method for operating a network node. In this embodiment, a resource allocation is coordinated among a first network node and a second network node, and the first network node sends to a relay node a control signal that is indicative of a relative weight to attribute to the first network node in order to achieve the coordinated resource allocation. Further in this method, the first network node receives from the relay node a message relayed using the relative weight. In particular embodiments of this method, the resource allocation can be a load balancing among the first and second network nodes, or it can be physical coverage area among the first and second network nodes.

In accordance with yet another embodiment is a first network node that includes a processor coupled to a memory, a transmitter and a receiver. The processor is configured to coordinate over a data link (such as for example an Iub link) a resource allocation among the first network node and a second network node. The transmitter is configured to wirelessly send to a relay node a control signal indicative of a relative weight to attribute to the first network node to achieve the coordinated resource allocation. The receiver is configured to receive from the relay node a message relayed using the relative weight.

These and other embodiments are detailed more fully below.

### BRIEF DESCRIPTION OF THE DRAWINGS

The foregoing and other features and advantages of the present invention should be more fully understood from the following detailed description of illustrative embodiments taken in conjunction with the accompanying Figures in which like elements are numbered alike in the several Figures:

FIG. 1 illustrates one example of an RDMA system in accordance with the exemplary embodiments of this invention.

FIG. 2A illustrates a functional block diagram of one embodiment of an ad hoc network scenario.

FIG. 2B illustrates a functional block diagram of one embodiment of a cellular network scenario.

FIG. 3A is a scatter diagram illustrating a layout of a large random relay network having a random topology.

FIG. 3B is a scatter diagram illustrating a layout of a large random relay network having a parallel topology.

FIG. 3C is a scatter diagram illustrating a layout of a large random relay network having a co-centric topology.

FIG. 3D is a legend for use with FIG. 3A, FIG. 3B and FIG. 3C.

FIG. 4 is a graph illustrating a plot of Receive Signal to Noise Ratio (SNR) vs. Bit Error Rate (BER) for networks without spatial separation.

FIG. 5 is a graph illustrating a plot of Transmit SNR vs. BER for different network topologies.

FIG. 6 is a graph illustrating a comparison of link performance for a large relay network.

FIG. 7 is a block diagram illustrating one embodiment of electronic devices suitable for use with the RDMA system of FIG. 1.

FIG. 8 is a block diagram illustrating one embodiment of a method for implementing the RDMA system of FIG. 1.

### DETAILED DESCRIPTION

In accordance with exemplary embodiments of this invention, a novel Relay Division Multiple Access (RDMA) technique is provided for use in cellular wireless communication systems. The RDMA approach may be viewed as an enhanced type of spatial division multiplexing (SDM) that may use relay nodes to form more orthogonal (less interfering) communication links. In the RDMA system it is assumed that the mobile nodes, such as cellular phones, disposed within a cell may be multiplexed using some technique, such as CDMA, TDMA, FDMA, OFDMA, and that the present invention provides a mechanism to separate links used in different cells, different sectors of the same Base Station (BS) or any combination thereof. It should be appreciated that although the exemplary embodiments are disclosed herein with regards to different cells, the invention may also cover different sectors of the same BS or any combination thereof.

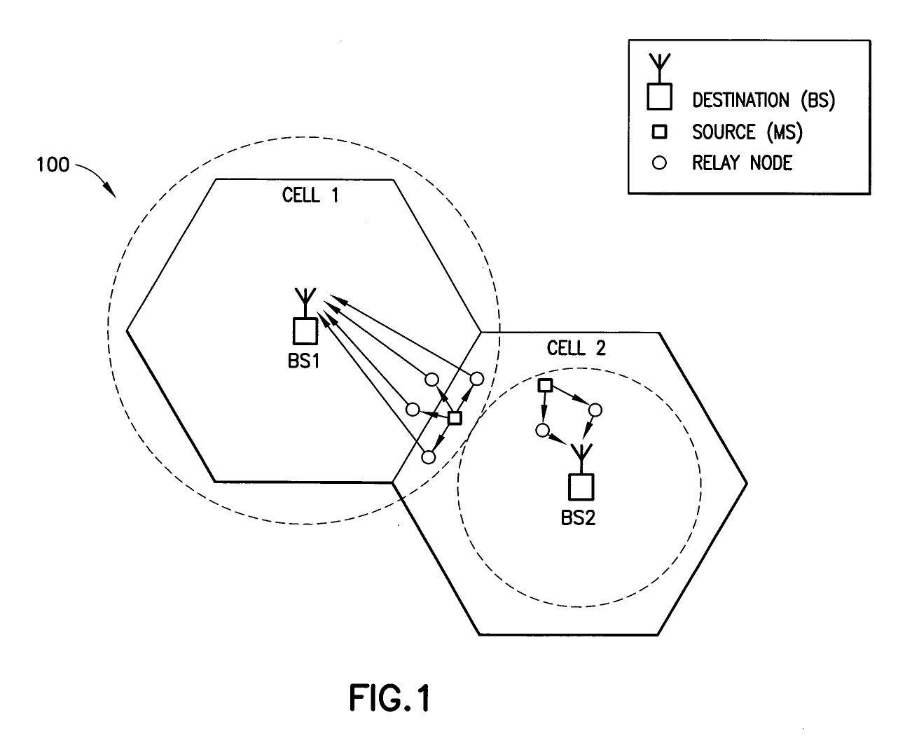

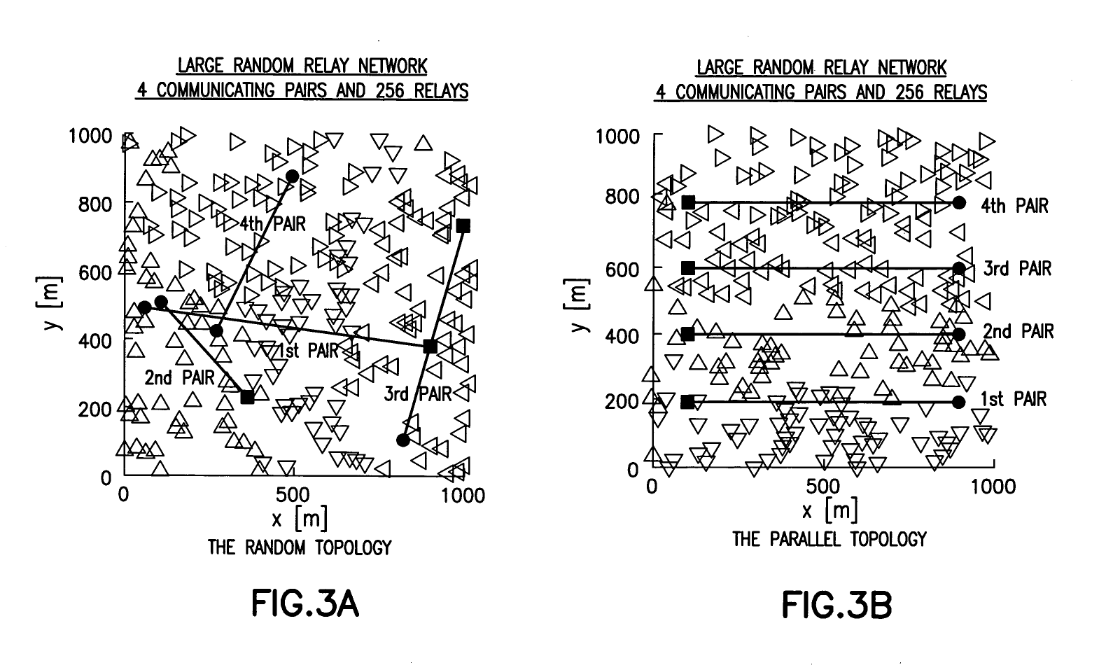

Referring to FIG. 1, consider a cellular network system 100, wherein for simplicity communication is in the uplink direction only (i.e. from a mobile node or mobile station (MS) to the base station (BS)). This simplification is for convenience only, as the teachings in accordance with the exemplary embodiments of the invention may be used in the uplink and/or the downlink directions. Additionally, assume that the network 100 includes only one sub-carrier or sub-channel and at least two BS's (BS1, BS2) that form two adjacent cells (Cell1, Cell2). Further assume that at least two MS's (MS1, MS2) use the same channel and transmit signals to separate BS's. It should be appreciated that the exemplary embodiments of this invention are not limited for use with only BSs as connection points into a cellular network infrastructure and that the exemplary embodiments of the invention can be used as well in wireless local area networks that employ access points (APs) and in so-called ad hoc networks. In accordance with exemplary embodiments of this invention, FIG. 1 also assumes the presence of at least two amplify-and-forward (AF) relay nodes that perform a matched filtering protocol, wherein one embodiment of a matched filtering protocol suitable for use during the practice of this invention is described hereinafter with reference to FIGS. 3-6.

It should be appreciated that the ensuing discussion considers a special type of wireless ad hoc network which may be referred to as an interference relay network, where a set of source-destination pairs concurrently communicate through a set of half-duplex relays. The novel weighted relaying protocol that is introduced herein generalizes certain previously proposed protocols and provides an efficient method for allocating relay nodes (also referred to simply as relays) to the communicating pairs. Discussed also is performance scaling in an interference relay network with a low number of communicating pairs. Also discussed is the effect of spatial separation and different network topologies, where it is shown that spatial separation may improve the performance of interference relay networks and that the behavior may largely depend on the network topology.

The interference relay network concept has been proposed by H. Bölcskei and R. U. Nabar, “Realizing MIMO gains without user cooperation in large single-antenna wireless networks”, in Proc. IEEE ISIT, Chicago, Ill., June/July 2004, p. 20. As opposed to avoiding interfering sources, the impact of interfering signals is mitigated by active scatterers (see A. Wittneben and B. Rankov, “Impact of cooperative relays on the capacity of rank-deficient MIMO channels”, in Proc. 12th IST Summit on Mobile Wireless Communications, Aveiro, Portugal, June 2003, pp. 421-425) using a particular amplify-and-forward relaying concept. A relay protocol described in H. Bölcskei, R. U. Nabar, Ö. Oyman, and A. J. Paulraj, “Capacity scaling laws in MIMO relay networks,” IEEE Trans. Wireless Comm., 2006, performs matched filtering and thereby orthogonalizes the channels of distinct communicating pairs in a distributed manner.

A capacity scaling analysis that was made of large interference relay networks shows that for a large number of source-destination pairs Nₛ, one would need Nᵣ∝Nₛ^{α+3} (α is a real valued constant) relays to achieve an end-to-end link capacity scaling of at least log(Nₛ^{α}) (see by V. I. Morgenshtern, H. Bölcskei, and R. U. Nabar, “Distributed orthogonalization in large interference relay networks,” in Proc. IEEE ISIT, Adelaide, Australia, September 2005, incorporated by reference herein in its entirety as if fully restated herein). Firstly, the results from the capacity scaling analysis are valid only when the number of source-destination pairs Nₛ is large. However, for practical cases it is beneficial to investigate the performance for a small number of communicating pairs. Secondly, the analysis does not consider spatially distributed networks, and the path-loss distribution is defined only by upper and lower bounds for the energy received through a link. By modeling spatially distributed networks, the effect of path-loss distribution and spatial separation between the network nodes (of particular interest to this invention) may be investigated. It is shown that performance scaling for an interference relay network also works with a small number of communicating pairs. Further, the performance of interference relay networks varies significantly depending on the network topology.

Presented hereinafter is one embodiment of a system and channel model for an interference relay network and a review is made of the matched filtering operation for the relays. Consider a two-hop relaying network (Nₛ×Nᵣ×N_{d}) having Nₛ source nodes, Nᵣ relay nodes and N_{d} destination nodes. Particularly, one may concentrate on networks having an equal amount of sources and destinations (Nₛ=N_{d}) forming distinct communicating source-destination pairs (i.e. the first source communicates with the first destination and so on). The network operation may be as follows. A half-duplex time-division (frequency-division would operate similarly) that guarantees separation between the sources' and relays' signals is assumed. During a first time slot, the l th source transmits the signal xₗ and the k th relay receives the combined signal from all Nₛ sources and may be given by:

$${r}_{k} = {\sum }_{l = 1}^{{N}_{s}} {h}_{k , l} {x}_{l} + {n}_{k} , k = 1 , 2 , … , {N}_{r} ; \qquad ( 1 )$$

where nₖ denotes the receiver noise component at the k th relay and h_{k,l} denotes the channel coefficient between the l th source and the k th relay. During the second time slot the relays amplify-and-forward the received signals, i.e. the k th relay transmits the signal tₖ=βₖrₖ, where βₖ is the complex-valued AF-gain. The l th destination receives a combination of all Nᵣ relayed signals and may be given by:

$${y}_{l} = {\sum }_{k = 1}^{{M}_{r}} {f}_{l , k} {t}_{k} + {z}_{l} , l = 1 , 2 , … , {N}_{s} . ; \qquad ( 2 )$$

where zₗ denotes the receiver noise component at the l th destination and f; k denotes the channel coefficient between the k th relay and the l th destination.

As non-limiting assumptions, the noise components zₖ and nₗ are assumed to be uncorrelated additive white Gaussian noise with variance σₙ², and the channel coefficients f_{l,k} and h_{k,l} are assumed to be Rayleigh block fading. The average receive power is defined by a path-loss model Pᵣ=Pₜ/d^{2.3}, where Pₜ is the transmission power of the sources and relays and the distance d between the nodes is defined by the spatially distributed network geometry.

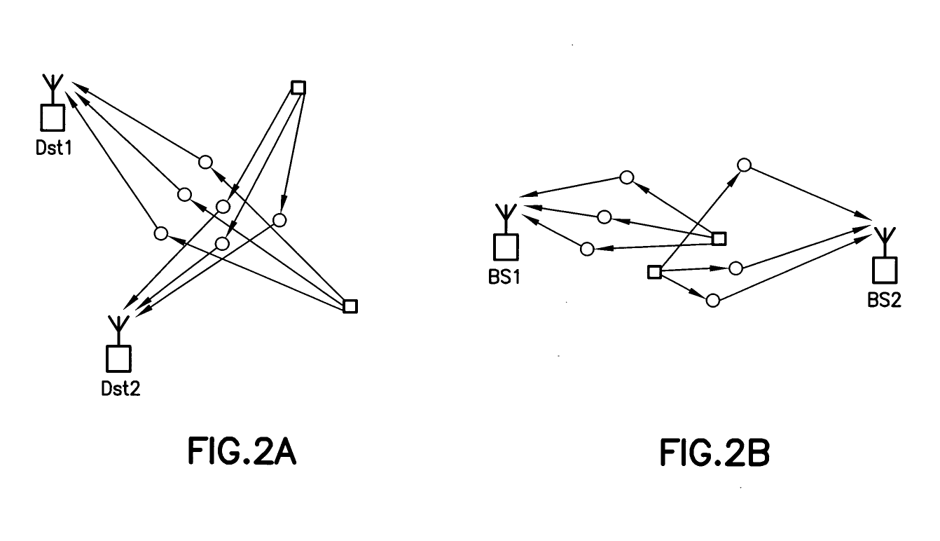

A novel general weighted relaying protocol may be introduced, wherein the protocol is well suited for use by the relay nodes shown in FIG. 1, FIG. 2A and FIG. 2B, discussed further hereinafter. The matched filtering AF-gain factor at the k th relay may be given by:

$${β}_{k} = {τ}_{k} {\sum }_{n = 1}^{{N}_{s}} {γ}_{k , n} {ⅇ}^{- j ( arg ( {h}_{k , n} ) + arg ( {f}_{n , k} ) )} , ; \qquad ( 3 )$$

where γ_{k,n} is the weighting or power allocation coefficient and τₖ is a power normalization factor. It should be appreciated that the various proposed relaying protocols cited herein may be viewed as special cases of the novel protocol also described herein. For example, in A. F. Dana and B. Hassibi, “On the power efficiency of sensory and ad-hoc wireless networks,” IEEE Trans. Inf. Theory, 2003, submitted, every relay assists every communicating pair using equal gain combining, i.e., γ_{k,n}=1 for all k and n. For the simulations discussed herein, the protocol presented in H. Bölcskei, R. U. Nabar, Ö. Oyman, and A. J. Paulraj, “Capacity scaling laws in MIMO relay networks,” IEEE Trans. Wireless Comm., 2006, to appear, may be assumed to be used for the relaying operation, wherein each relay may assist only one communicating pair. The set of relays is partitioned into Nₛ equal-sized subsets, wherein each subset is allocated to assist one source-destination pair. The relays are assumed to know and use only the phase information of the backward and forward channels for the assisted communicating pair, and an estimate of the average received power. Denote that the k th relay assists the communicating pair p(k). Thus, by setting the weights as:

$${γ}_{k , n} = \{ \begin{matrix}1 , & if n = p ( k ) \\ 0 , & otherwise\end{matrix} , ; \qquad ( 4 )$$

the matched filtering AF-gain factor at the k th relay becomes
βₖ=τₖe^{-j(arg(h}^{_{k,p(k)}}⁾+arg(f^{_{ρ(k),k}}⁾; (5)
where

$${τ}_{k} = {( {\sum }_{l = 1}^{{N}_{s}} E [ {\vert {h}_{k , l} \vert}^{2} ] + {σ}_{n}^{2} )}^{- 1 / 2}$$

is the power normalization ensuring that E[|tₖ|²]=1. Because of the matched filtering, the assisted communicating pair's signal is forwarded coherently, while the other communicating pairs' signals are repeated non-coherently.

Various exemplary and non-limiting network topologies are now discussed, including a network without spatial separation and various examples of spatially distributed networks with different degrees of organization. All spatially distributed networks are assumed for convenience to have an equal number of nodes, but the topologies and the geometries vary. For the situation where the network was without spatial separation, a (4×4^{α+3}×4) network was considered for comparison purposes, as well as to investigate the performance scaling with a low number of communicating pairs Nₛ. The network was assumed to not use any path-loss model or spatial separation between the communicating links, and to include uncorrelated channels. The mean receive SNR at every relay is the same for every source signal and the mean receive SNR at every destination is the same for every relay signal. Furthermore the relays' receive SNR is equal to the destinations' receive SNR. This network structure is similar to the system analyzed in V. I. Morgenshtern, H. Bölcskei, and R. U. Nabar, “Distributed orthogonalization in large interference relay networks,” in Proc. IEEE ISIT, Adelaide, Australia, September 2005 (incorporated by reference herein in its entirety as if fully restated herein). The performance scaling was examined for α=−1,0,1,2 and a low number of communicating pairs.

In the random (4×4⁴×4) network the sources, destinations and relays are assumed to be randomly scattered with uniform distribution on a square area of 1000×1000 meters. One example of the random network is illustrated in FIG. 3A. The random network is the scenario with the smallest degree of organization where the position of every node is random.

In a parallel (4×4⁴×4) network (see FIG. 3B) the sources on the left communicate with the destinations on the right. The communication links are parallel and of the same length. The relays are assumed to be randomly placed with uniform distribution on a square area of 1000×1000 meters. As in the random network the relays are randomly placed, but the fixed source and destination nodes give some degree of organization.

In the co-centric (4×4⁴×4) network (see FIG. 3C), all sources are located in one point. The relays form a ring, which is centered on the sources and the destinations are randomly located on a yet larger ring. This may be considered to be the most organized topology because all nodes' positions are more or less fixed compared to the random or parallel networks of FIG. 3A and FIG. 3B, respectively. The co-centric network topology corresponds to a case where a number of users close to one another need to communicate simultaneously to distant base stations, and are assisted by a ring of relays.

Discussed now is a relay allocation method that maximizes the effective receive SNR at the destinations. The described relay allocation decision is centralized, however it should be appreciated that adaptive methods may be used to make it decentralized. The effective signal-to-noise ratio at the destination for the received signal transmitted by the source and amplified and forwarded by a relay can be calculated as:

$${SNR}_{eff} = \frac{{SNR}_{sr} {SNR}_{rd}}{{SNR}_{sr} + {SNR}_{rd} + 1} ; \qquad ( 6 )$$

where SNRₛᵣ is the relay's receive SNR when it receives the source's signal, and SNR_{rd} is the destination's receive SNR when it receives the relay's signal. At the start of the allocation process all relays are assumed to be unallocated. Then each communicating pair selects, such as in a round robin manner, the relay that offers the highest SNR_{eff} to assist its communication from the set of yet unallocated relays. This iterative selection process continues until all relays are allocated. The relay allocation for the different networks is illustrated in FIG. 3.

While this particular allocation scheme may not be optimal, it still yields reasonable results. Furthermore it guarantees that none of the communicating pairs is left unassisted. The equal amount of relays allocated to all communicating pairs leads, however, to left-over relays. The left-over relays are selected last and their effective SNR is low for each communicating pair. They can be seen, for example, in the top right corner of the random network (FIG. 3A), or at the southwest sector of the ring of relays in the co-centric network (FIG. 3C).

Discussed now is the performance scaling for a low number of communicating pairs, and the effect of spatial distribution and different network topologies. The results are illustrated with simulation results. The following exemplary and non-limiting conditions were assumed for making bit-error-rate (BER) simulations on the system model described above: (a) the signals are BPSK modulated; (b) the sources and the relays transmit their signal with the same mean power; (c) the noise power is normalized to unity and the results are displayed against the transmit SNR at d=0 m, i.e., the ratio of power transmitted by a single node to noise power at the receiving node; and (d) the average distance between arbitrary nodes in the network is approximately 500 m, which results in a typical path-loss of 62 dB.

In low SNR areas the interference relay networks are noise limited and the BER decreases when increasing the transmit power. When further increasing the transmit power the BER typically saturates in a BER floor. At this point the network is interference limited and increasing the transmit power does not improve the BER.

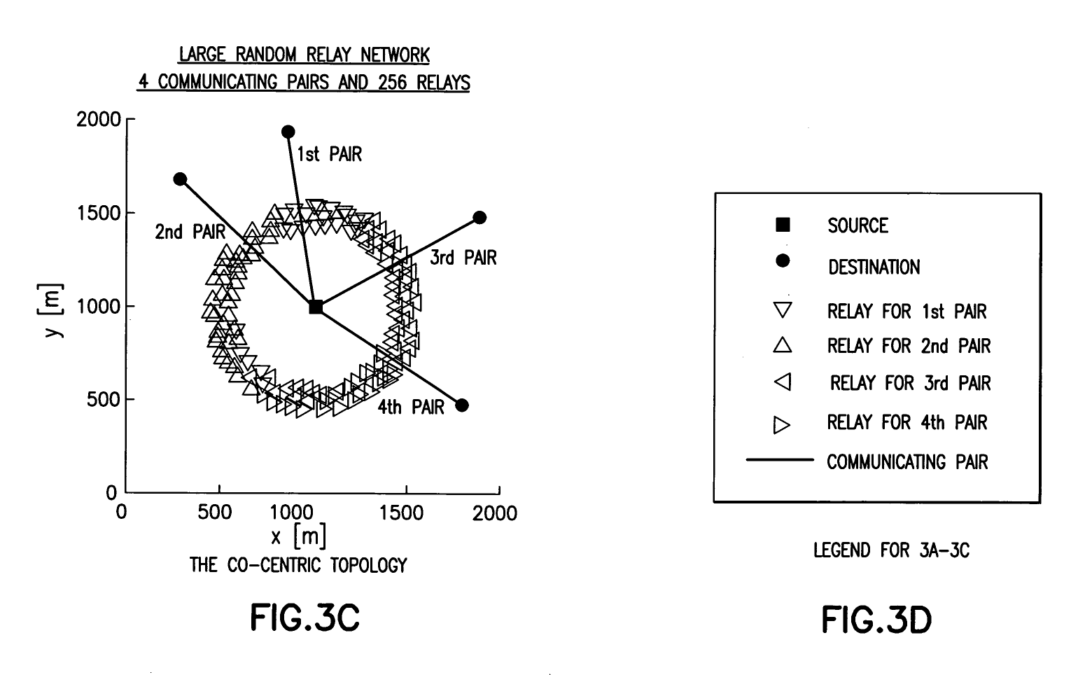

First, the (4×4^{a+3}×4) network without any spatial separation was simulated. The performance of the network was compared for different values α=−1,0,1,2 and the performance scaling was examined with a low number of communicating pairs. Reference in this regard can be made to FIG. 4. For α=−1 (16 relays) and α=0 (64 relays) the bit-error-rates are greater than 10% and no communication is possible. For α=1 or Nₛ⁴ (256) relays the BER is about 1% and communication is possible. The distributed orthogonalization works very well for α=2 or Nₛ⁵ relays but it requires 1024 relays for 4 communicating pairs. This suggests that the capacity scaling results are also valid for a low number of communicating pairs.

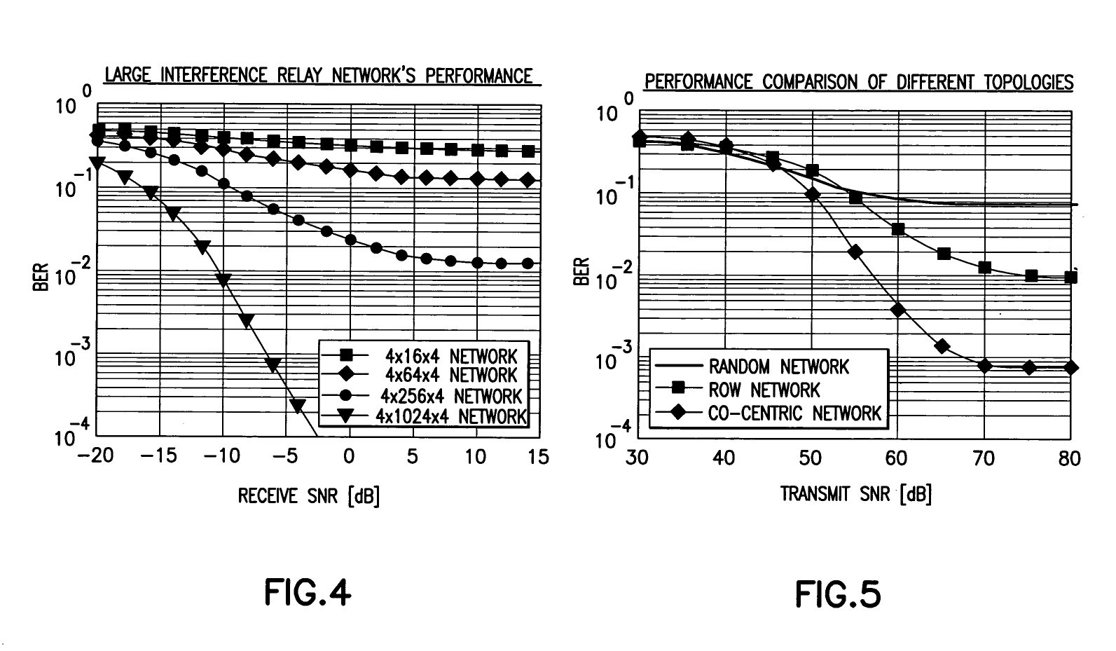

With regard now to a comparison of network topologies, in further simulations there was investigated the case of Nₛ⁴ relays (α=1) and spatially distributed networks. The results for the different network topologies are illustrated in FIG. 5. The performance increases when the network becomes more organized. Note that the parallel topology achieves very similar performance as the same-sized network without spatial separation. Both scenarios have a BER of approximately 1% at high SNR, and the slopes of the BER curves are substantially identical. The random topology can be seen to suffer most from the spatial separation, and its performance is similar to the (4×64×4) network without spatial separation, which can be interpreted that the “effective number” of relays decreases by the factor of 4.

In the foregoing discussion a comparison was made between the average BER values for the different network topologies and because of the symmetry in the parallel and the co-centric topologies, it may be expected that the BER is similar for each communicating pair. On the contrary, for the random network the interference situation is quite different for each link. Therefore, a comparison is made of the BER of the different links in the random network.

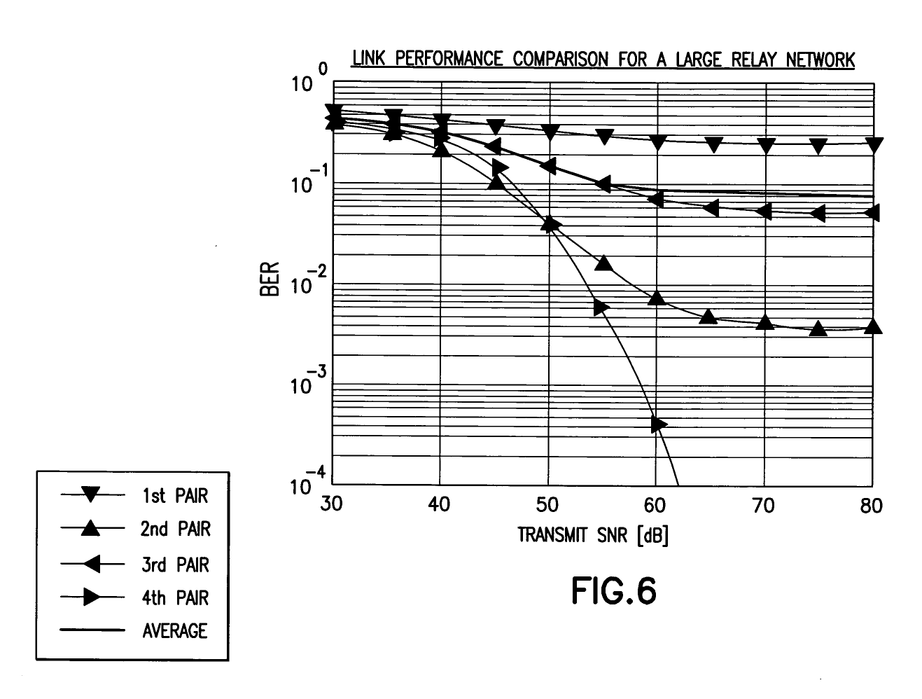

With specific regard to the link performance of the random network, and referring to FIG. 6, there is a large difference in link performance between the different pairs. Note that the second and fourth pairs achieve quite good performances with BER floors of 0.4% and less than 0.01%, respectively. The first and third communicating pairs have a higher BER floor of about 5% and 25%, respectively, which also dominate the average BER performance. The first pair suffers from having longer link span than the other pairs and both the first and third pairs suffer from the interfering relays located in the vicinity of the destinations. For example, relays allocated to the third pair near the third destination are closer to the first source and, as a result, they mainly relay the first source signal.

In other words, the distributed orthogonalization works well for two communicating pairs and poorly for the other two. The first pair's performance is similar to the network (4×16×4) without spatial separation. At the same time the fourth pair's behavior is similar to the (4×1024×4) without spatial separation. The effective number of relays allocated to the fourth pair is 64 times larger than the effective number of relays allocated to the first pair. Still, however, the actual number of relays allocated for all pairs is the same.

Based on the foregoing discussion it can be concluded that the (experimental) behavior of the interference relay network without spatial separation, and with a low number of communicating pairs, is similar to the (analytical) behavior with a high number of communicating pairs analyzed by V. I. Morgenshtern, H. Bölcskei, and R. U. Nabar, “Distributed orthogonalization in large interference relay networks,” in Proc. IEEE ISIT, Adelaide, Australia, September 2005 (incorporated by reference herein in its entirety as if fully restated herein).

The simulation result presented above clearly illustrates that the network topology has a crucial effect. Random networks have the least optimum performance, whereas more organized networks achieve the same or better performance than a network without spatial separation. This indicates that spatial separation can be exploited. It was also noted that for the random network, the distributed orthogonalization does not work well for all communicating pairs and the resulting link performances were shown to be very different.

It should be appreciated that the relay nodes need not be dedicated hardware/software modules or devices, but may in fact be other MSs that are not currently actively transmitting or receiving their own data, and therefore may be allocated for assisting the communications of other MSs. It should be further appreciated that some or all of the various communication nodes in the network 100 may have two or more antennas, and may be capable of performing beamforming, MIMO transmission or any other multi-antenna technique.

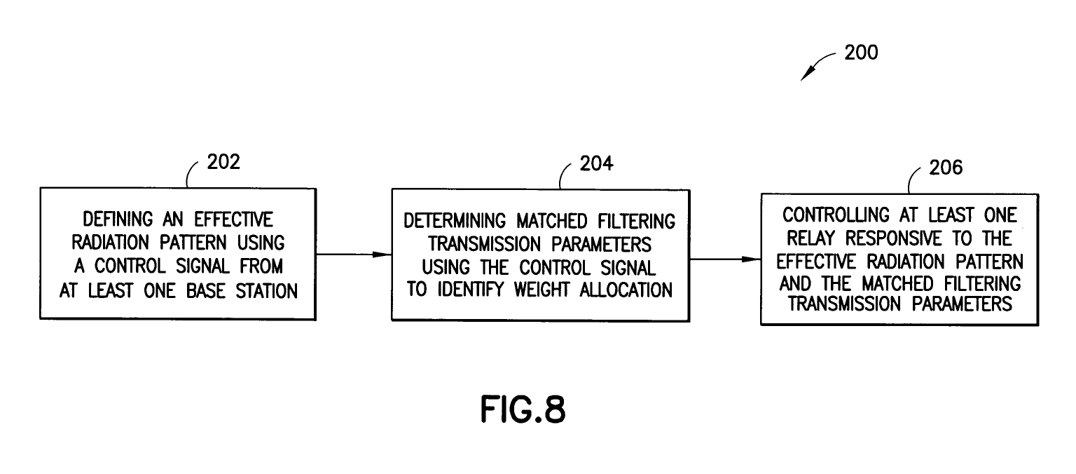

Referring to FIG. 8, in accordance with one embodiment of a method 200 for controlling the relay node usage by the BS's is illustrated and described as follows. The multiple relay nodes may be jointly controlled by those multiple BS's having the relay node(s) in their coverage area. Control signals from the BS's define the effective radiation patterns combined by the relay nodes, as shown in operational block 202. Additionally, the radiation pattern of each relay node, e.g. beamforming weights, selection of sector antenna, etc. may be controlled by the BS's. Relative priority setting weights may depend on these controls signals, wherein the control signals may be a part of a competition for relay nodes, where multiple BS's compete for the usage of a particular relay node. Alternatively the BS's may agree on relative priorities. In addition, the BS's may set constraints to the relays (e.g., transmit power, null steering) in order to control the interference induced by the relay not aiding the given BS.

The relay nodes may have sufficient memory to store multiple signals to forward and re-transmit a given stored signal multiple times, possibly on demand, wherein the BS's may signal different control signals for each re-transmission. The relay nodes may use the control signals from the BS's to determine the matched filtering protocol transmission parameters, as shown in operational block 204. This operation results in a weight allocation, when using the general protocol that was discussed above with regard to FIGS. 3-6, as well as in relay node selection, which can be considered as a special case of the general protocol. It should be appreciated that the relay may assist in several communication links to different BS's and as the relay is assisting, it may additionally perform beamforming depending on which BS it is receiving from/transmitting to. Thus, in one embodiment, the control signal may tell which BS to assist and the relay may determine the beamforming weights. Relay node selection was described by V. I. Morgenshtern, H. Bolcskei, and R. U. Nabar, “Distributed Orthogonalization in Large Interference Relay Networks”, IEEE International Symposium on Information Theory, September 2005, and is incorporated by reference herein in its entirety as if fully restated herein. Those relay nodes that are located, for example, at the cell border may assist the operation of multiple communication links and the weight allocation may then be used to determine the relative gains. The relays may then be controlled responsive to the effective radiation pattern and/or the matched filtering protocol transmission parameters, as shown in operational block 206.

The relay nodes may be used in general, for performing multiple access by separating the sources (e.g., MS's on the uplink, BS's on the downlink) using matched filtering relaying.

The relay nodes further improve frequency reuse, and also provide extensively overlapping coverage areas for the B S's which, in turn, enable the balancing of coverage areas of the BS's, balancing the load of the BS's, and additionally providing for facilitating soft handover between cells.

In one example of a non-limiting and exemplary embodiment, the invention may be used in a cellular CDMA system. In this example, and in the downlink direction, the BS's may not have a sufficient number of orthogonal spread spreading codes and the use of the exemplary embodiments of this invention may allow a plurality of BS's to use the same spreading code.

In another example of a non-limiting and exemplary embodiment, the invention may be used in a cellular OFDM(A) system. In this type of system multiple relays placed close to the cell border are capable of transmitting to multiple BS's. The BS's select the relays that should assist in uplink and/or downlink communication between BS and MS based on, as non-limiting examples, path-loss measurements and/or SNR. The BS's signal the transmission parameters, the priority information (for example, the priority information may be used to determine the relative weights (γₙ) in equation 3) and the transmission resources (e.g., one or more of timeslot, channel, sub-channel, frame, sub-frame) that the relays should assist with to the selected relays. Based on the transmission parameters and the priority information received by the relays, they calculate the transmission weight for the matched filtering protocol. The relay may operate in full-duplex or half-duplex mode, where the BS's assign transmission resources to the relay. The use of these exemplary embodiments improves the SINR for MS at the cell border.

In yet another example of a non-limiting and exemplary embodiment, this invention may be used in an OFDMA system, where the relay demodulates the received signal and the BS's may signal different transmission parameters for different sub-carriers, groups of sub-carriers and/or sub-channels. It should be appreciated that sub-channel specific radiation pattern control, e.g., weighting can be used for any multiple access method, such as TDMA, FDMA, CDMA or any combination thereof.

It should be appreciated that, in those systems where the relays assist multiple communication links to the same BS, separated by, e.g. CDMA, OFDMA, the BS may group the users and determine the transmission parameters in order to maximize, for example, the signal quality for each group. Moreover, the amplify-and-forward operation of the relay nodes typically does not require decoding of the received signal. This is a particularly useful property when a MS functions as the relay node, as the implementation is simplified, security is improved and the signaling is reduced. Furthermore, the load and coverage balancing properties are also advantageous. One reason is that the coverage area of BS's can be adjusted according to the load situation. For example, the first base station in FIG. 1 (BS1) is illustrated as having an increased coverage area than the more heavily loaded second base station (BS2). Additionally, the frequency reuse factor of unity furthermore provides a very efficient utilization of spectral resources.

FIG. 2A and FIG. 2B depict an example of what may be referred to as worst case ad hoc network and cellular network scenarios, respectively. Random networks with intersecting links, as illustrated in FIG. 2A, may be considered as worst case scenarios for interference in the relay network described in V. I. Morgenshtern, H. Bölcskei, and R. U. Nabar, “Distributed orthogonalization in large interference relay networks,” in Proc. IEEE ISIT, Adelaide, Australia, September 2005, incorporated by reference herein in its entirety as if fully restated herein. However, the inherent organization of the cellular network ideally removes the possibility of having heavily intersecting links. In a cellular network, it can be guaranteed that the BS's are located at different locations. While two MS's connected to different BS's may be near to each other, the use of the RDMA in accordance with the exemplary embodiments of this invention guarantees that the relay nodes allocated for different links are spatially separated (see FIG. 2B). This spatial separation is advantageous for the use with RDMA.

It should be appreciated that an additional time slot or an orthogonal sub-channel may be reserved for the half-duplex relaying operation. Further, consideration may be made to obtain a fair selection if other MS's are used as relay nodes, as overloading some MS's with relaying responsibilities may consume their battery power prematurely. It should be further appreciated that the same operation can also be used without the presence of interfering links.

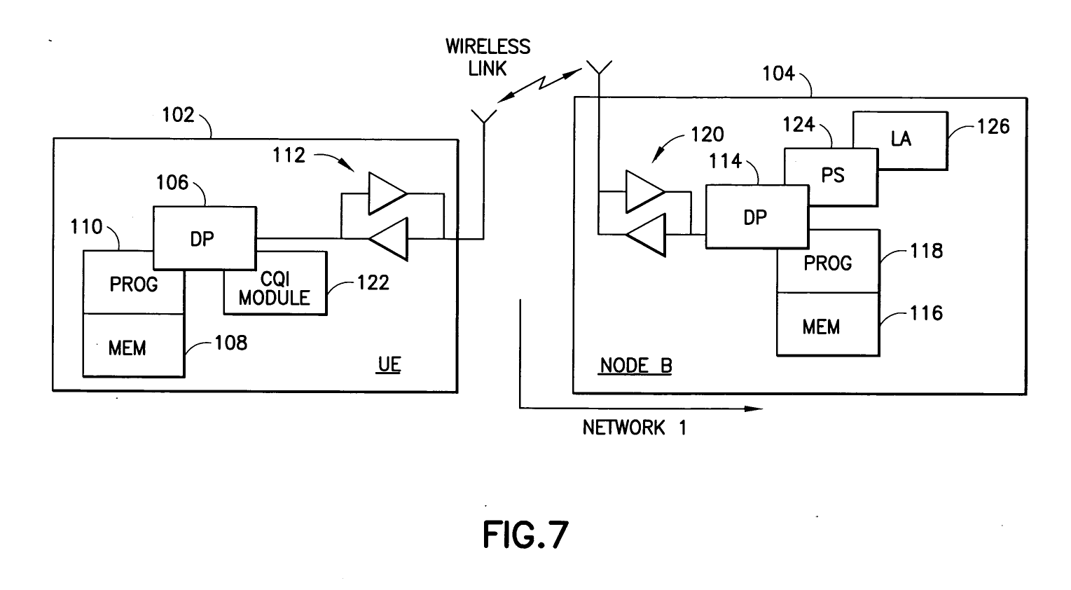

Referring to FIG. 7, a simplified block diagram of various electronic devices that are suitable for use in practicing the exemplary embodiments of this invention is illustrated. In FIG. 7, a wireless network, such as cellular network system 100, is adapted for communication with a UE 102 via a Node B (base station) 104, wherein the network 100 may include a serving RNC (not shown), or other radio controller function. The UE 102 may include a data processor (DP) 106, a memory (MEM) 108 that stores a program (PROG) 110, and a suitable radio frequency (RF) transceiver 112 for bidirectional wireless communications with the Node B 104, which may also include a DP 114, a MEM 116 that stores a PROG 118, and a suitable RF transceiver 120. Though not separately depicted, an amplifier for applying the gain associated with the weightings detailed herein is disposed within the transceiver. The Node B 104 may be coupled via a data path (e.g., Iub) to the server or other RNC. At least one of the PROGs 110 and 118 is assumed to include program instructions that, when executed by the associated DP, enable the electronic device to operate in accordance with the exemplary embodiments of this invention, as will be discussed below in greater detail.

Related more specifically to the exemplary embodiments of this invention, the UE 102 is shown to include a CQI unit or module 122 that is assumed to be responsible for generating and transmitting CQI reports in accordance with the exemplary embodiments of this invention, and the Node B 104 is assumed to include a Packet Scheduler (PS) 124 and Link Adaptation (LA) 126 units or modules that respond to the CQI reports sent by the UE 102. The modules 122, 124 and 126 may be embodied in software, firmware and/or hardware, as is appropriate. In general, the exemplary embodiments of this invention may be implemented by computer software executable by the DP 106 of the UE 102 and the other DPs, or by hardware, or by a combination of software and/or firmware and hardware.

In general, the various embodiments of the UE 102 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The MEMs 108 and 116 may be of any type suitable to the local technical environment and may be implemented using any suitable data storage technology, such as semiconductor-based memory devices, magnetic memory devices and systems, optical memory devices and systems, fixed memory and removable memory. The DPs 106 and 114 may be of any type suitable to the local technical environment, and may include one or more of general purpose computers, special purpose computers, microprocessors, digital signal processors (DSPs) and processors based on multi-core processor architecture, as non-limiting examples.

Based on the foregoing, it should be appreciated that the embodiments of this invention provide a method, apparatus and computer program product(s) to enable a relay node to relay communication signals between a MS and a plurality of wireless network connection points, where the wireless network connection points may be one or more of BS's, such as those found in a cellular communication network, and access nodes, such as those found in an ad hoc communication network. The embodiments of this invention may relate generally to the relay node operations, including the matched filtering operations discussed herein, as well as to methods, apparatus and computer program product(s) for implementing the relay node operations (it being assumed that a relay node will include at least one data processor and a memory for storing program instructions, as well as for storing and buffering communication signals as discussed herein). The embodiments of this invention may also relate generally to the BS operations, as well as to methods, apparatus and computer program product(s) for implementing the allocating and control of relay nodes and the signaling communications with same discussed above (it being assumed that a base station will also include at least one data processor and a memory for storing program instructions).

In general, the embodiments of this invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Moreover, embodiments of the invention may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

Various modifications and adaptations may become apparent to those skilled in the relevant arts in view of the foregoing description, when read in conjunction with the accompanying drawings. However, any and all modifications of the teachings of this invention will still fall within the scope of the embodiments of this invention.

Furthermore, some of the features of the various embodiments of this invention may be used to advantage without the corresponding use of other features. As such, the foregoing description should be considered as merely illustrative of the principles, teachings and exemplary embodiments of this invention, and not in limitation thereof.

What is claimed is:

1. A method comprising:
receiving a first control signal from a first network node;
receiving a second control signal from a second network node;
determining from the received first and second control signals a first relative weight and a second relative weight;
receiving a first message and a second message;
relaying the received first message by transmitting the received first message after amplifying the received first message according to the first relative weight; and
relaying the received second message by transmitting the received second message after amplifying by transmitting the received first message according to the second relative weight.

2. The method of claim 1, wherein the first control signal comprises a first priority from which the first relative weight is determined and the second control signal comprises a second priority from which the second relative weight is determined.

3. The method of claim 1, wherein the received first and second messages are received within a first time slot and relayed after said amplifying in a second time slot.

4. The method of claim 3, wherein the received first and second messages are received from different sources.

5. The method of claim 3, wherein the received first and second messages are relayed to different destinations.

6. The method of claim 3, wherein the received first and second messages are relayed in a full duplex mode.

7. The method of claim 1, wherein the received first message is received from the first network node and the received second message is received from the second network node.

8. The method of claim 1, wherein the received first message is relayed to the first network node and the received second message is relayed to the second network node.

9. The method of claim 1, further comprising:
determining a first phase information from at least one of a channel over which the received first message was received, a channel over which the first control signal was received, and a channel over which the received first message is to be relayed;
determining a second phase information from at least one of a channel over which the received second message was received, a channel over which the second control signal was received, and a channel over which the received second message is to be relayed;
determining matched filter protocol parameters from the first and second phase information; and
determining from the matched filter protocol parameters an effective radiation pattern;
and wherein relaying the received first and second messages comprises using the effective radiation pattern to transmit the received first and second messages.

10. The method of claim 9, wherein
the first phase information is determined from both the channel over which the received first message was received and the channel over which the received first message is to be relayed; and
the second phase information is determined from both the channel over which the received second message was received and the channel over which the received second message is to be relayed.

11. The method of claim 9, wherein using the effective radiation pattern comprises selecting transmit antennas and beamforming using the selected transmit antennas to transmit the received first and second messages.

12. The method of claim 1, wherein each of the received first and second messages is relayed without decoding either of said received first and second messages.

13. The method of claim 1, executed by a mobile station.

14. The method of claim 1, executed by a relay network node.

15. The method of claim 1, wherein each of the first and second network nodes comprise one of a base station and a network access point.

16. An apparatus comprising:
a receiver configured to receive a first control signal from a first network node and a second control signal from a second network node;
a processor coupled to a memory embodying computer instructions and to the receiver, configured to determine from the received first and second control signals a first relative weight and a second relative weight;
an amplifier coupled to a transmitter configured to relay a received first message by transmitting the received first message after amplifying according to the first relative weight, and to relay a received second message by transmitting the received second message after amplifying according to the second relative weight.

17. The apparatus of claim 16, wherein the first control signal comprises a first priority from which the first relative weight is determined and the second control signal comprises a second priority from which the second relative weight is determined.

18. The apparatus of claim 16, wherein the received first and second messages are received within a first time slot and transmitted after said amplifying in a second time slot.

19. The apparatus of claim 18, wherein the received first and second messages are received from different sources.

20. The apparatus of claim 18, wherein the received first and second messages are relayed to different destinations.

21. The apparatus of claim 18, wherein the received first and second messages are relayed in a full duplex mode.

22. The apparatus of claim 16, wherein the received first message is received from the first network node and the received second message is received from the second network node.

23. The apparatus of claim 16, wherein the received first message is relayed to the first network node and the received second message is relayed to the second network node.

24. The apparatus of claim 16, wherein the processor is further configured to
determine a first phase information from at least one of a channel over which the received first message was received, a channel over which the first control signal was received, and a channel over which the received first message is to be relayed;
determine a second phase information from at least one of a channel over which the received second message was received, a channel over which the second control signal was received, and a channel over which the received second message is to be relayed;
determine matched filter protocol parameters from the first and second phase information; and
determine from the matched filter protocol parameters an effective radiation pattern;
and wherein the transmitter is configured to relay the received first and second messages using the effective radiation pattern to transmit the received first and second messages.

25. The apparatus of claim 24, wherein:
the first phase information is determined from both the channel over which the received first message was received and the channel over which the received first message is to be relayed; and
the second phase information is determined from both the channel over which the received second message was received and the channel over which the received second message is to be relayed.

26. The apparatus of claim 24, further comprising a plurality of transmit antennas, and wherein using the effective radiation pattern comprises selecting transmit antennas and beamforming using the selected transmit antennas to transmit the received first and second messages.

27. The apparatus of claim 16, wherein the apparatus is configured to relay each of the received first message and the received second message without decoding either of said received first and second messages.

28. The apparatus of claim 16, comprising a mobile station.

29. The apparatus of claim 16, comprising a relay network node.

30. The apparatus of claim 16, wherein each of the first and second network nodes comprises one of a base station and a network access point.

31. The apparatus of claim 16, wherein the first and second control signals are received, and the received first and second messages are relayed in an ad hoc network.

32. The apparatus of claim 16, wherein the first and second control signals are received, and the received first and second messages are relayed in a mobile cellular network.

33. A computer program product of machine-readable instructions, tangibly embodied on a memory and executable by a digital data processor, to perform actions directed toward relaying messages in a network, the actions comprising:
determining, from a first control signal received from a first network node and from a second control signal received from a second network node, a first relative weight and a second relative weight;
relaying a received first message by transmitting the received first message after amplifying the received first message according to the first relative weight; and
relaying a received second message by transmitting the received second message after amplifying the received second message according to the second relative weight.

34. The computer program product of claim 33, wherein the first control signal comprises a first priority from which the first relative weight is determined and the second control signal comprises a second priority from which the second relative weight is determined.

35. The computer program product of claim 33, wherein the first and second received messages are received within a first time slot and relayed after said amplifying in a second time slot.

36. The computer program product of claim 33, wherein the received first and second messages are relayed in a full duplex mode.

37. The computer program product of claim 33, the actions further comprising:
determining a first phase information from at least one of a channel over which the received first message was received, a channel over which the first control signal was received, and a channel over which the received first message is to be relayed;
determining a second phase information from at least one of a channel over which the received second message was received, a channel over which the second control signal was received, and a channel over which the received second message is to be relayed;
determining matched filter protocol parameters from the first and second phase information; and
determining from the matched filter protocol parameters an effective radiation pattern;
and wherein relaying the received first and second messages comprises using the effective radiation pattern to transmit the received first and second messages.

38. The computer program product of claim 37, wherein
the first phase information is determined from both the channel over which the received first message was received and the channel over which the received first message is to be relayed; and
the second phase information is determined from both the channel over which the received second message was received and the channel over which the received second message is to be relayed.

39. The computer program product of claim 33, wherein each of the received first message and the received second message are relayed without decoding either of said received first message or received second message.

40. An apparatus comprising:
means for receiving a first control signal from a first network node and a second control signal from a second network node;
means for determining from the received first and second control signals a first relative weight and a second relative weight;
means for relaying a first received message by transmitting the first received message after amplifying according to the first relative weight, and for relaying a second received message by transmitting the second received message after amplifying according to the second relative weight.

41. The apparatus of claim 40, wherein
the means for receiving comprises a receiver;
the means for determining comprises a processor coupled to a memory of computer readable instructions; and
the means for relaying comprises an amplifier coupled to a transmitter.

42. A method for operating a network node comprising:
coordinating a resource allocation among a first network node and a second network node;
sending from the first network node to a relay node a control signal indicative of a relative weight to attribute to the first network node to achieve the coordinated resource allocation; and
receiving at the first network node from the relay node a message relayed using the relative weight.

43. The method of claim 42, wherein the resource allocation comprises load balancing among the first network node and the second network node.

44. The method of claim 42, wherein the resource allocation comprises network coverage area among the first network node and the second network node.

45. A first network node comprising:
a processor coupled to memory configured to coordinate over a data link a resource allocation among the first network node and a second network node;
a transmitter configured to wirelessly send to a relay node a control signal indicative of a relative weight to attribute to the first network node to achieve the coordinated resource allocation; and
a receiver configured to receive from the relay node a message relayed using the relative weight.

46. The first network node of claim 45, wherein the resource allocation comprises load balancing among the first network node and the second network node.

47. The first network node of claim 47, wherein the resource allocation comprises network coverage area among the first network node and the second network node.
